(19) United States
(12) Patent Application Publication
(10) Pub. No.: US 2014/0354158 A1
(43) Pub. Date: Dec. 4, 2014

(54) Lighting Circuit and Luminaire

(71) Applicant: TOSHIBA LIGHTING & TECHNOLOGY CORPORATION, Yokosuka-shi (JP)

(72) Inventor: Takuro Hiramatsu, Yokosuka-shi (JP)

(73) Assignee: TOSHIBA LIGHTING & TECHNOLOGY CORPORATION, Yokosuka-shi (JP)

(21) Appl. No.: 14/143,165

(22) Filed: Dec. 30, 2013

(30) Foreign Application Priority Data
May 30, 2013 (JP) 2013-114034

(51) Int. Cl. H05B 33/08

(52) U.S. Cl. CPC H05B 33/0815
USPC 315/123

(57) ABSTRACT

A lighting circuit includes an input unit, an output unit, a rectifying circuit, first and second switching circuits, a dimming signal generating circuit, and first and second control units. The input unit is connected to a control device that outputs an alternating-current voltage. The output unit is connected to a light-emitting unit. The rectifying circuit converts the alternating-current voltage into a rectified voltage. The first switching circuit converts the rectified voltage into a first voltage with a first switching element. The second switching circuit converts the first voltage into a second voltage with a second switching element and outputs the second voltage to the output unit. The dimming signal generating circuit generates a dimming signal. The first control unit controls the first switching element. The second control unit controls the second switching element.

### CROSS-REFERENCE TO RELATED APPLICATIONS

This application is based upon and claims the benefit of priority from Japanese Patent Application No. 2013-114034, filed on May 30, 2013; the entire contents of which are incorporated herein by reference.

### FIELD

Embodiments described herein relate generally to a lighting circuit and a luminaire.

### BACKGROUND

As one of luminaries, there is a low-voltage halogen lamp that is lit with a voltage of about 12 V. The low-voltage halogen lamp is connected to a control device including an electronic transformer. The electronic transformer converts a commercial power supply of AC 100 V into AC 12 V power and supplies the power to the low-voltage halogen lamp.

There is also a luminaire including a light-emitting element and a lighting circuit for lighting the light-emitting element. There is a movement to replace the low-voltage halogen lamp with the luminaire including the light-emitting element for the purpose of a reduction in power consumption and the like. In the replacement, it is desired that the luminaire including the light-emitting element can be connected to the control device including the electronic transformer and used. However, if the luminaire including the light-emitting element is connected to the control device including the electronic transformer, the operation of the electronic transformer becomes unstable. For example, flickering and noise occur when the luminaire is lit. Therefore, in the lighting circuit and the luminaire including the lighting circuit, it is desired that the luminaire can be normally lit even if the luminaire is connected to the control device including the electronic transformer.

### BRIEF DESCRIPTION OF THE DRAWINGS

FIG. 1 is a block diagram schematically showing a luminaire according to a first embodiment;

FIGS. 2A to 2C are schematic diagrams showing the luminaire according to the first embodiment;

FIG. 3 is a block diagram schematically showing another luminaire according to the first embodiment; and

FIG. 4 is a block diagram schematically showing a luminaire according to a second embodiment.

### DETAILED DESCRIPTION

In general, according to an embodiment, there is provided a lighting circuit including an input unit, an output unit, a rectifying circuit, a first switching circuit, a second switching circuit, a dimming signal generating circuit, a first control unit, and a second control unit. The input unit is electrically connected to a control device that converts a first alternating-current voltage subjected to conduction angle control into a second alternating-current voltage having a different effective value and outputs the second alternating-current voltage. The output unit is electrically connected to a light-emitting unit. The light-emitting unit includes a first terminal, a second terminal, and a light-emitting element electrically connected between the first terminal and the second terminal and configured to emit light when an electric current flows from the first terminal to the second terminal. The rectifying circuit is electrically connected between the input unit and the output unit and rectifies the second alternating-current voltage input via the input unit and converts the second alternating-current voltage into a rectified voltage. The first switching circuit is electrically connected between the rectifying circuit and the output unit, includes a first switching element, and converts the rectified voltage into a first voltage according to switching of the first switching element. The first switching element includes a first electrode, a second electrode, and a first control electrode for switching a first state in which an electric current flows between the first electrode and the second electrode and a second state in which an electric current flowing between the first electrode and the second electrode is smaller than the electric current in the first state. The first electrode and the second electrode are connected to the light-emitting element in parallel. The second switching circuit is electrically connected between the first switching circuit and the output unit, includes a second switching element, and converts the first voltage into a second voltage of a direct current according to switching of the second switching element and outputs the second voltage of the direct current to the output unit. The second switching element includes a third electrode, a fourth electrode, and a second control electrode for switching a third state in which an electric current flows between the third electrode and the fourth electrode and a fourth state in which an electric current flowing between the third electrode and the fourth electrode is smaller than the electric current in the third state. The third electrode and the fourth electrode are connected to the light-emitting element in series. The dimming signal generating circuit is electrically connected between the input unit and the rectifying circuit or between the rectifying circuit and the first switching circuit and generates a dimming signal corresponding to the conduction angle control on the basis of one of the second alternating-current voltage and the rectified voltage. The first control unit is electrically connected to the first control electrode, controls the switching of the first switching element, and sets an effective value of an electric current flowing to the input unit to be equal to or larger than a predetermined value. The second control unit is electrically connected to the second control electrode and the dimming signal generating circuit, controls the switching of the second switching element, and sets the second voltage to a voltage value corresponding to the dimming signal.

According to another embodiment, there is provided a luminaire including a light-emitting unit and a lighting circuit. The light-emitting unit includes a first terminal, a second terminal, and a light-emitting element electrically connected between the first terminal and the second terminal and configured to emit light when an electric current flows from the first terminal to the second terminal. The lighting circuit includes an input unit, an output unit, a rectifying circuit, a first switching circuit, a second switching circuit, a dimming signal generating circuit, a first control unit, and a second control unit. The input unit is electrically connected to a control device that converts a first alternating-current voltage subjected to conduction angle control into a second alternating-current voltage having a different effective value and outputs the second alternating-current voltage. The output unit is electrically connected to a light-emitting unit. The rectifying circuit is electrically connected between the input unit and the output unit and rectifies the second alternating-current voltage input via the input unit and converts the second alternating-current voltage into a rectified voltage. The first switching circuit is electrically connected between the rectifying circuit and the output unit, includes a first switching element, and converts the rectified voltage into a first voltage according to switching of the first switching element. The first switching element includes a first electrode, a second electrode, and a first control electrode for switching a first state in which an electric current flows between the first electrode and the second electrode and a second state in which an electric current flowing between the first electrode and the second electrode is smaller than the electric current in the first state. The first electrode and the second electrode are connected to the light-emitting element in parallel. The second switching circuit is electrically connected between the first switching circuit and the output unit, includes a second switching element, and converts the first voltage into a second voltage of a direct current according to switching of the second switching element and outputs the second voltage of the direct current to the output unit. The second switching element includes a third electrode, a fourth electrode, and a second control electrode for switching a third state in which an electric current flows between the third electrode and the fourth electrode and a fourth state in which an electric current flowing between the third electrode and the fourth electrode is smaller than the electric current in the third state. The third electrode and the fourth electrode are connected to the light-emitting element in series. The dimming signal generating circuit is electrically connected between the input unit and the rectifying circuit or between the rectifying circuit and the first switching circuit and generates a dimming signal corresponding to the conduction angle control on the basis of one of the second alternating-current voltage and the rectified voltage. The first control unit is electrically connected to the first control electrode, controls the switching of the first switching element, and sets an effective value of an electric current flowing to the input unit to be equal to or larger than a predetermined value. The second control unit is electrically connected to the second control electrode and the dimming signal generating circuit, controls the switching of the second switching element, and sets the second voltage to a voltage value corresponding to the dimming signal.

Embodiments are explained below with reference to the drawings.

Note that the drawings are schematic or conceptual. Relations between thicknesses and widths of sections, ratios of sizes among the sections, and the like are not always the same as real ones. Even if the same sections are shown, dimensions and ratios of the sections are sometimes shown different depending on the drawings.

Note that, in this specification and the drawings, components same as components already explained with reference to the drawing are denoted by the same reference numerals and signs and detailed explanation of the components is omitted as appropriate.

### First Embodiment

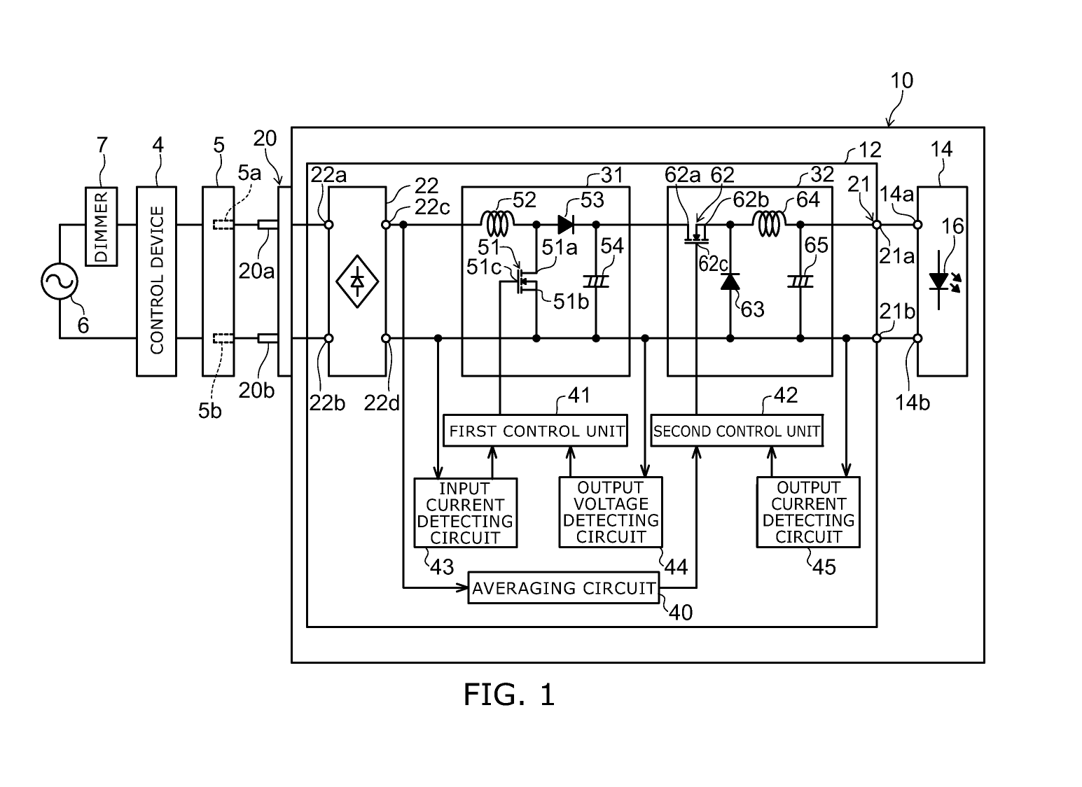

FIG. 1 is a block diagram schematically showing a luminaire according to a first embodiment.

As shown in FIG. 1, a luminaire 10 includes a lighting circuit 12 and a light-emitting unit 14. The light-emitting unit 14 includes a first terminal 14a, a second terminal 14b, and a light-emitting element 16. The light-emitting element 16 is electrically connected between the first terminal 14a and the second terminal 14b. The lighting circuit 12 converts an input voltage into a voltage corresponding to the light-emitting element 16 and outputs the voltage to the light-emitting unit 14 to thereby cause the light-emitting element 16 to emit light.

In the light-emitting element 16, a light emitting diode (LED) is used. That is, in this example, the luminaire 10 is an LED lamp. The light-emitting element 16 is not limited to the LED and may be, for example, an organic light emitting diode (OLED) or a laser diode.

The light-emitting element 16 emits light when an electric current flows from the first terminal 14a to the second terminal 14b. In other words, if the potential of the first terminal 14a is set higher than the potential of the second terminal 14b and a direct-current voltage is applied between the first terminal 14a and the second terminal 14b, the light-emitting element 16 emits light. For example, an anode of the light-emitting element 16, which is the LED, is electrically connected to the first terminal 14a. A cathode of the light-emitting element 16 is electrically connected to the second terminal 14b. Consequently, when an electric current is supplied or a voltage is applied to the first terminal 14a and the second terminal 14b as explained above, the light-emitting element 16 emits light.

In the light-emitting unit 14, for example, a plurality of the light-emitting elements 16 are provided. The light-emitting elements 16 may be connected, for example, in series, may be connected in parallel, may be connected in series and in parallel. Electrical connection of the light-emitting elements 16 may be arbitrary connection in which each of the light-emitting elements 16 emits light when an electric current is supplied or a voltage is applied as explained above. The number of the light-emitting elements 16 may be arbitrary. Only one light-emitting element 16 may be provided.

The light-emitting element 16 emits light if a voltage equal to or larger than a lower limit value is applied between the first terminal 14a and the second terminal 14b. Specifically, a voltage equal to or larger than a forward voltage of the light-emitting element 16, which is the LED, is applied between the first terminal 14a and the second terminal 14b, whereby the light-emitting element 16 emits light. If the plurality of light-emitting elements 16 are provided in the light-emitting unit 14, the lower limit value is a sum of forward voltages of the light-emitting elements 16.

The lighting circuit 12 includes an input unit 20, an output unit 21, a rectifying circuit 22, a first switching circuit 31, a second switching circuit 32, an averaging circuit 40 (a dimming signal generating circuit), a first control unit 41, and a second control unit 42.

The input unit 20 is used for electrical connection to a control device 4. In the input unit 20, for example, a pair of pins 20a and 20b (first and second fitting sections) is provided. The sizes such as the lengths and diameters of the pair of pins 20a and 20b are substantially the same. The input unit 20 is detachably held in a socket 5. The socket 5 includes a pair of holes 5a and 5b (first and second sections to be fit). The control device 4 and the luminaire 10 are electrically connected by inserting the pair of pins 20a and 20b into the holes 5a and 5b. In this example, the input unit 20 is a so-called cap. The luminaire 10 is mechanically held in the socket 5 via the input unit 20 and electrically connected to the socket 5 via the input unit 20. The input unit 20 is not limited to the cap and may be, for example, a wire. That is, the luminaire 10 is not limited to an illumination lamp electrically connected to the control device 4 via the cap and may be, for example, an illumination module electrically connected to the control device 4 via the wire.

The sizes such as depths and diameters of the holes 5a and 5b are substantially the same. The pins 20a and 20b are reversibly connectable to the holes 5a and 5b. That is, the pin 20a is connectable to one of the holes 5a and 5b. The pin 20b is connectable to the other of the holes 5a and 5b in a state in which the pin 20a is connected. Note that the first and second fitting sections and the first and second sections to be fit are not limited to the above-mentioned example. In particular, the first and second fitting sections and the first and second sections to be fit optimally have shapes for making it possible to reversibly connect the first and second fitting sections to the first and second sections to be fit. For example, the first and second sections to be fit may be concave sections.

The socket 5 is electrically connected to the control device 4. The luminaire 10 is electrically connected to the control device 4 via the socket 5. For example, an alternating-current power supply 6 and a dimmer 7 are electrically connected to the control device 4. The alternating-current power supply 6 outputs, for example, alternating-current voltage of 100 V. The alternating-current power supply 6 is, for example, a commercial power supply. The dimmer 7 generates a first alternating-current voltage subjected to conduction angle control from a power supply voltage of the alternating-current power supply 6. The dimmer 7 inputs the first alternating-current voltage to the control device 4.

As the conduction angle control of the dimmer 7, for example, there are a method of phase control (leading edge) for controlling a phase conducting in a period from zero-cross of an alternating-current voltage to a maximum value of an absolute value of the alternating-current voltage and a method of inverse phase control (trailing edge) for controlling a phase shut off in a period from the maximum value of the absolute value of the alternating-current voltage to the zero-cross of the alternating-current voltage. The conduction angle control of the dimmer 7 may be either the phase control method or the inverse phase control method. In this example, the dimmer 7 connected in series between the control device 4 and the alternating-current power supply 6 is shown as an example. The dimmer 7 is not limited to this and may be an arbitrary dimmer capable of subjecting the power supply voltage of the alternating-current power supply 6 to the conduction angle control.

The control device 4 converts the first alternating-current voltage into a second alternating-current voltage and outputs the second alternating-current voltage to the luminaire 10. An effective value of the second alternating-current voltage is different from an effective value of the first alternating-current voltage. The effective value of the second alternating-current voltage is lower than the effective value of the first alternating-current voltage. The control device 4 converts, for example, the first alternating-current voltage having an effective value of 100 V into the second alternating-current voltage having an effective value of 12 V. The control device 4 includes, for example, an electronic transformer. The control device 4 converts, with the electronic transformer, the first alternating-current voltage into the second alternating-current voltage. The control device 4 is, for example, a stabilizer for lighting a low-voltage halogen lamp. The luminaire 10 is used instead of the low-voltage halogen lamp or the like. The luminaire 10 can be directly connected to the control device 4, which is designed to be adapted to the low-voltage halogen lamp or the like, and used.

The lighting circuit 12 converts the second alternating-current voltage output from the control device 4 into a direct-current voltage and outputs the direct-current voltage to the light-emitting unit 14 to thereby cause the light-emitting elements 16 to emit light. The lighting circuit 12 performs dimming of the light-emitting unit 14 in synchronization with the second alternating-current voltage subjected to the conduction angle control.

The output unit 21 is electrically connected to the light-emitting unit 14. The output unit 21 includes a pair of output ends 21a and 21b. In this example, the output end 21a is electrically connected to the first terminal 14a and the output end 21b is electrically connected to the second terminal 14b.

The output unit 21 may be an arbitrary connection point electrically connectable to the light-emitting unit 14. The light-emitting unit 14 may be provided on a substrate different from a substrate on which the lighting circuit 12 is provided or may be provided in a substrate same as the substrate on which the lighting circuit 12 is provided. If the light-emitting unit 14 is provided on the different substrate, the output unit 21 is, for example, a connection point for connecting the substrates to each other. If the light-emitting unit 14 is provided on the same substrate, the output unit 21 is, for example, a connection point for mounting the light-emitting element 16.

The rectifying circuit 22 is electrically connected between the input unit 20 and the output unit 21. The rectifying circuit 22 rectifies the second alternating-current voltage input via the input unit 20 and converts the second alternating-current voltage into a rectified voltage. The rectified voltage is, for example, a pulsating voltage. In the following explanation, it is assumed that the rectified voltage is the pulsating voltage. As the rectifying circuit 22, for example, a diode bridge formed by combining four rectifying elements is used. That is, the rectifying circuit 22 is a full-wave rectifier.

The rectifying circuit 22 includes a pair of input terminals 22a and 22b, a high-potential output terminal 22c, and a low-potential output terminal 22d. The input terminal 22a is electrically connected to the pin 20a. The input terminal 22b is electrically connected to the pin 20b. The rectifying circuit 22 converts the second alternating-current voltage input via the input terminals 22a and 22b into a pulsating voltage and outputs the pulsating voltage from the high-potential output terminal 22c and the low-potential output terminal 22d. The potential of the low-potential output terminal 22d is set to reference potential (e.g., ground potential). The potential of the high-potential output terminal 22c is set to potential higher than the potential of the low-potential output terminal 22d.

The rectifying circuit 22 may be a half-wave rectifier or the like. The pulsating voltage may be a pulsating flow subjected to full-wave rectification or may be a pulsating flow subjected to half-wave rectification. As the rectifying circuit 22, for example, a Schottky barrier diode is used. Consequently, for example, it is possible to obtain satisfactory responsiveness.

The first switching circuit 31 is electrically connected between the rectifying circuit 22 and the output unit 21. The first switching circuit 31 includes a first switching element 51 and converts the pulsating voltage into a first voltage according to switching of the first switching element 51. The first switching element 51 includes a first electrode 51a, a second electrode 51b, and a first control electrode 51c. The first control electrode 51c is used for switching a first state in which an electric current flows between the first electrode 51a and the second electrode 51b and a second state in which an electric current flowing between the first electrode 51a and the second electrode 51b is smaller than the electric current in the first state.

In the first switching element 51, the first electrode 51a and the second electrode 51b are connected to the light-emitting element 16 in parallel. In other words, a current route between the first electrode 51a and the second electrode 51b are connected to the light-emitting element 16 in parallel.

The first switching element 51 is, for example, an FET of an n-channel type. For example, the first electrode 51a is a drain, the second electrode 51b is a source, and the first control electrode 51c is a gate. The first state is, for example, an ON state and the second state is, for example, an OFF state. The first switching element 51 may be, for example, an FET of a p-channel type or may be a bipolar transistor or the like.

In this example, the first switching circuit 31 further includes an inductor 52, a diode 53, and a capacitor 54. One end of the inductor 52 is electrically connected to the high-potential output terminal 22c. The other end of the inductor 52 is electrically connected to the first electrode 51a. The second electrode 51b is electrically connected to the low-potential output terminal 22d. An anode of the diode 53 is electrically connected to the first electrode 51a. A cathode of the diode 53 is electrically connected to one end of the capacitor 54. The other end of the capacitor 54 is electrically connected to the low-potential output terminal 22d. That is, in this example, the first switching circuit 31 is a rising voltage chopper circuit.

The first switching circuit 31 generates a direct-current voltage at both ends of the capacitor 54 according to the switching of the first switching element 51. That is, in this example, the first voltage is a direct current. An absolute value of the direct-current voltage is larger than an effective value of the pulsating voltage. The first switching circuit 31 converts the pulsating voltage output from the rectifying circuit 22 into a direct-current voltage that rises higher than the pulsating voltage. The first switching circuit 31 converts, for example, a pulsating voltage having an effective value of 12 V into a direct-current voltage having an absolute value of about 30V. Note that the first switching circuit 31 is not limited to the rising voltage chopper circuit and may be, for example, a polarity inversion circuit. In this case, the first voltage may be a pulsating flow.

The second switching circuit 32 is electrically connected between the first switching circuit 31 and the output unit 21. The second switching circuit 32 includes a second switching element 62 and converts the first voltage into the second voltage of a direct current according to switching of the second switching element 62 and outputs the second voltage of the direct current to the output unit 21. The second switching element 62 includes a third electrode 62a, a fourth electrode 62b, and a second control electrode 62c. The second control electrode 62c is used for switching a third state in which an electric current flows between the third electrode 62a and the fourth electrode 62b and a fourth state in which an electric current flowing between the third electrode 62a and the fourth electrode 62b is smaller than the electric current in the third state.

In the second switching element 62, the third electrode 62a and the fourth electrode 62b are connected to the light-emitting element 16 in series. In other words, a current route between the third electrode 62a and the fourth electrode 62b is connected to the light-emitting element 16 in series.

The second switching element 62 is, for example, an FET of an n-channel type. For example, the third electrode 62a is a drain, the fourth electrode 62b is a source, and the second control electrode 62c is a gate. The third state is, for example, an ON state and the fourth state is, for example, an OFF state. The second switching element 62 may be, for example, an FET of a p-channel type or may be a bipolar transistor or the like.

In this example, the second switching circuit 32 further includes a diode 63, an inductor 64, and a capacitor 65. The third electrode 62a is electrically connected to the cathode of the diode 53 (one end on a high-potential side of the capacitor 54). The fourth electrode 62b is electrically connected to a cathode of the diode 63. An anode of the diode 63 is electrically connected to the low-potential output terminal 22d. One end of the inductor 64 is electrically connected to the fourth electrode 62b. The other end of the inductor 64 is electrically connected to one end of the capacitor 65. The other end of the capacitor 65 is electrically connected to the low-potential output terminal 22d. That is, in this example, the second switching circuit 32 is a falling voltage chopper circuit.

The second switching circuit 32 generates a direct-current voltage at both ends of the capacitor 65 according to the switching of the second switching element 62. That is, the second switching circuit 32 generates a second voltage at both the ends of the capacitor 65. An absolute value of the second voltage is smaller than an absolute value (or an effective value) of the first voltage. The second switching circuit 32 converts the first voltage into the second voltage that falls lower than the first voltage. The second switching circuit 32 converts, for example, the first voltage of a direct current of about 30 V into the second voltage of a direct current of about 12 V. The second switching circuit 32 converts, for example, the first voltage into the second voltage of a direct current corresponding to the light-emitting element 16 and outputs the second voltage of the direct current to the output unit 21. Consequently, an electric current flows from the first terminal 14a to the second terminal 14b and the light-emitting element 16 emits light.

The averaging circuit 40 is electrically connected between the rectifying circuit 22 and the first switching circuit 31. The averaging circuit 40 is electrically connected to, for example, the high-potential output terminal 22c. Consequently, a pulsating voltage is input to the averaging circuit 40. The averaging circuit 40 generates, on the basis of the pulsating voltage, a dimming signal corresponding to the conduction angle control of the dimmer 7. The averaging circuit 40 generates, as the dimming signal, an averaged signal obtained by averaging the pulsating voltage. The averaging circuit 40 averages, for example, the pulsating voltage and converting the pulsating voltage into a direct-current voltage having a voltage value corresponding to the conduction angle control to thereby generate the averaged signal. Consequently, it is possible to detect a conduction angle of the second alternating-current voltage and the pulsating voltage referring to the voltage value of the averaged signal. The averaging circuit 40 is, for example, an integrating circuit including a resistor and a capacitor.

The first control unit 41 is electrically connected to the first control electrode 51c. The first control unit 41 controls switching of the first switching element 51. Consequently, the first control unit 41 controls a voltage value of the first voltage. The first control unit 41 drives the first switching element 51 and feeds an electric current to the first switching circuit 31 to thereby set an effective value of an alternating current flowing to the input unit 20 to be equal to or larger than a predetermined value. In other words, the first control unit 41 sets an effective value of an alternating current flowing to the control device 4 to be equal to or larger than the predetermined value. More specifically, the predetermined value is a current value necessary for causing the electronic transformer of the control device 4 to normally operate.

An input current detecting circuit 43 is electrically connected to the first control unit 41. The input current detecting circuit 43 is electrically connected to, for example, an output side of the rectifying circuit 22. The input current detecting circuit 43 may be electrically connected to an input side of the rectifying circuit 22. The input current detecting circuit 43 detects a current value of an input current flowing to the input unit 20 and inputs a detection result to the first control unit 41.

The first control unit 41 controls the switching of the first switching element 51 on the basis of the detection result of the input current detecting circuit 43. The first control unit 41 controls the switching of the first switching element 51, for example, on the basis of the detection result and substantially fixes an effective value of the input current. The first control unit 41 determines, for example, on the basis of the detection result of the input current detecting circuit 43, a duty ratio of a pulse signal input to the first control electrode 51c. Consequently, the effective value of the input current is controlled to be substantially fixed. Note that “the effective value of the input current is fixed” means that, for example, a fluctuation range of the effective value of the input current is equal to or smaller than ±10% with respect to a center value of fluctuation.

An output voltage detecting circuit 44 is further electrically connected to the first control unit 41. The output voltage detecting circuit 44 is electrically connected to an output side of the first switching circuit 31. The output voltage detecting circuit 44 detects a voltage value of the first voltage output from the first switching circuit 31 and inputs a detection result to the first control unit 41.

The first control unit 41 controls the switching of the first switching element 51 on the basis of the detection result of the output voltage detecting circuit 44. That is, the first control unit 41 controls the switching of the first switching element 51 on the basis of the detection result of the input current detecting circuit 43 and the detection result of the output voltage detecting circuit 44. The first control unit 41 controls the switching of the first switching element 51, for example, on the basis of the detection results, substantially fixes the effective value of the input current, and substantially fixes the effective value (the absolute value) of the first voltage. Note that “the effective value of the first voltage is fixed” means that, for example, a fluctuation range of the effective value of the first voltage is equal to or smaller than ±10% with respect to the center of fluctuation.

The first control unit 41 sets the effective value of the first voltage to be equal to or larger than a lower limit value necessary for light emission of the light-emitting element 16. That is, the first control unit 41 sets the effective value of the first voltage to be equal to or larger than a forward voltage of the light-emitting element 16. The first control unit 41 substantially fixes, for example, an absolute value of the first voltage of a direct current to about 30 V.

The second control unit 42 is electrically connected to the second control electrode 62c and the averaging circuit 40. The second control unit 42 controls switching of the second switching element 62. Consequently, the second control unit 42 controls the second voltage to a voltage value corresponding to the averaged signal (the dimming signal). The second control unit 42 determines, for example, on the basis of the averaged signal, a duty ratio of a pulse signal input to the second control electrode 62c. Consequently, the voltage value of the second voltage is controlled to a value corresponding to the conduction angle control of the dimmer 7. Consequently, the light-emitting element 16 is dimmed according to the conduction angle control of the dimmer 7.

An output current detecting circuit 45 is electrically connected to the second control unit 42. The output current detecting circuit 45 is electrically connected to an output side of the second switching circuit 32. The output current detecting circuit 45 detects a current value of an output current output from the second switching circuit 32 and inputs a detection result to the second control unit 42. That is, the output current detecting circuit 45 detects a current value of an electric current flowing to the light-emitting unit 14.

The second control unit 42 controls the switching of the second switching element 62 on the basis of the detection result of the output current detecting circuit 45. The second control unit 42 controls the switching of the second switching element 62, for example, on the basis of the detection result and substantially fixes an absolute value of the output current.

The second control unit 42 determines, on the basis of the averaged signal received from the averaging circuit 40 and the detection result of the output current detecting circuit 45, the duty ratio of the pulse signal input to the second control electrode 62c. Consequently, the absolute value of the output current is controlled to be substantially fixed by a current value corresponding to the conduction angle control. Note that “the absolute value of the output current is fixed” means that, for example, a fluctuation range of the absolute value of the output current is equal to or smaller than ±10% with respect to a center value of fluctuation.

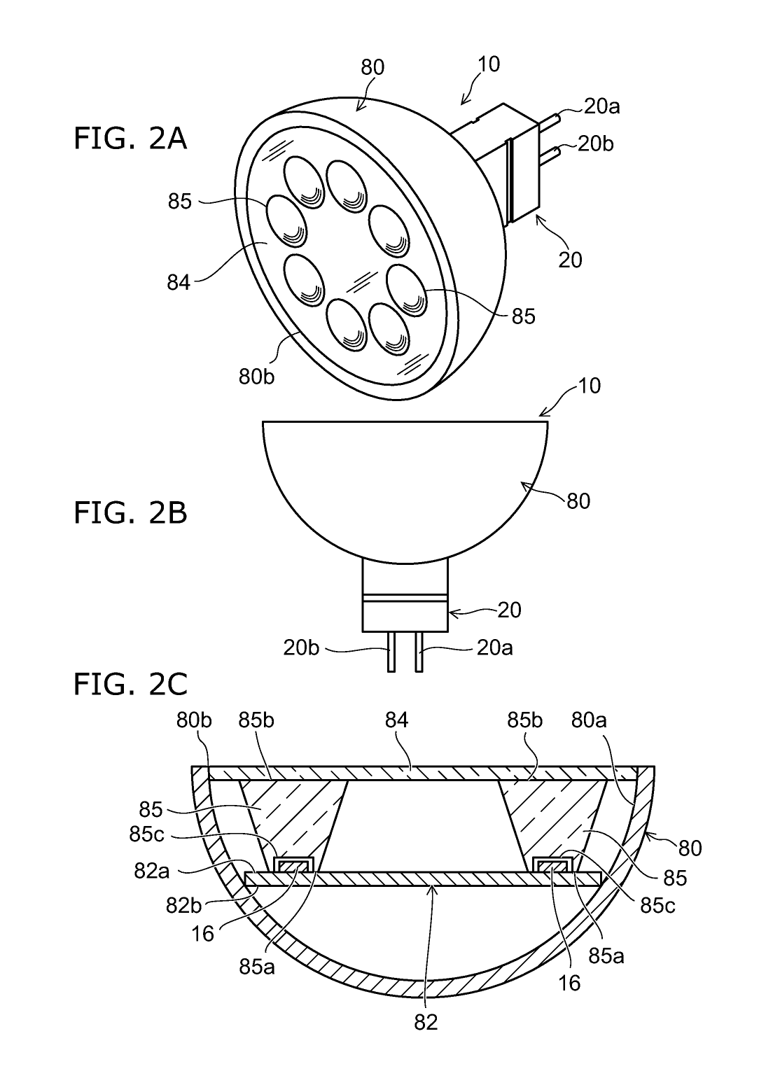

FIGS. 2A to 2C are schematic diagrams showing the luminaire according to the first embodiment.

FIG. 2A is a perspective view schematically showing the luminaire 10. FIG. 2B is a side view schematically showing the luminaire 10. FIG. 2C is a schematic sectional view showing a part of the luminaire 10 in enlargement.

As shown in FIGS. 2A to 2C, the luminaire 10 includes a case 80 and a substrate 82. FIG. 2C schematically shows a cross section of the case 80. The case 80 is formed in, for example, a bowl shape. The case 80 includes, for example, an inner surface 80a having a rotated paraboloid shape and an opening 80b. In other words, the opening 80b is an opened end of the inner surface 80a. The input unit 20 is provided on, for example, the outer surface of the case 80 on the opposite side of the opening 80b.

The substrate 82 is provided on the inside of the case 80. The substrate 82 is formed in, for example, a disc shape. The substrate 82 includes a surface 82a. The substrate 82 is provided, for example, on the inside of the case 80 with the surface 82a directed to the opening 80b side. The light-emitting element 16 is provided on the surface 82a. For example, the plurality of light-emitting elements 16 are arranged in a ring shape on the surface 82a. The substrate 82 includes a wiring pattern not shown in the figure. The light-emitting elements 16 are electrically connected to the wiring pattern in a state in which the light-emitting elements 16 are mounted on the surface 82a. Electrical connection of the light-emitting elements 16 to the lighting circuit 12 and the like is performed via, for example, the wiring pattern. Note that the arrangement of the light-emitting elements 16 on the surface 82a may be arbitrary.

In the case 80, a cover 84 and a lens 85 are further provided. The cover 84 closes the opening 80b of the case 80. The cover 84 is formed in, for example, a tabular shape. In this example, the cover 84 is formed in a disc shape. The cover 84 has optical transparency to lights emitted from the light-emitting elements 16 (hereinafter referred to as emitted lights). The cover 84 is, for example, transparent. As the cover 84, for example, plastics, glass, or the like is used.

A plurality of the lenses 85 are respectively provided to correspond to the light-emitting elements 16. The lenses 85 have optical transparency to the emitted lights of the light-emitting elements 16. The lenses 85 are, for example, transparent. As the lenses 85, for example, plastics, glass, or the like is used. The lenses 85 are provided, for example, between the substrate 82 and the cover 84. The lenses 85 may be integrated with, for example, the cover 84.

The lenses 85 include first ends 85a opposed to the light-emitting elements 16 and second ends 85b on the opposite side of the first ends 85a. Each of the lenses 85 is arranged to be opposed to each of the light-emitting elements 16. The emitted light from the light-emitting element 16 is made incident on the first end 85a of the lens 85. The lens 85 emits, for example, the emitted light, which is made incident from the first end 85a, from the second end 85b to thereby control a luminous intensity distribution angle of the emitted light. The lens 85 condenses, for example, the emitted light. The lens 85 sets, for example, the luminous intensity distribution angle of the emitted light to be equal to or smaller than a predetermined value. The lens 85 may be, for example, a lens that diffuses the emitted light.

At the first ends 85a of the lenses 85, concave sections 85c for covering the light-emitting elements 16 are provided. Consequently, for example, it is possible to improve incident efficiency of the emitted light on the lenses 85. More specifically, the first ends 85a are opposed to the light-emitting elements 16 on the inner bottom surfaces of the concave sections 85c. Note that the cover 84 and the lenses 85 are provided according to necessity and can be omitted as appropriate.

The case 80 is, for example, an MR16 type. The input unit 20 functioning as the cap is, for example, a GU5.3 type. That is, the luminaire 10 is an LED lamp of a so-called low-voltage halogen lamp type. The case 80 may be, for example, an AR111 type. The input unit 20 may be, for example, a G53 type. The shape of the case 80 and the shape of the input unit 20 may be, for example, arbitrary shapes conforming to the standard of the low-voltage halogen lamp type.

In the field of lighting, there is a movement to replace a low-voltage halogen lamp or the like with a luminaire including a light-emitting element such as an LED. In the replacement, it is desired that the luminaire can be directly connected to the control device 4 designed to correspond to the low-voltage halogen lamp or the like.

The electronic transformer has a characteristic that the electronic transformer does not stably operate unless a certain degree of an electric current is fed to the electronic transformer. Power consumption of the luminaire including the light-emitting element such as the LED is small compared with power consumption of the low-voltage halogen lamp. Therefore, for example, if a luminaire not including a switching circuit and the like is connected to the control device 4 including the electronic transformer, a necessary electric current cannot be fed and the operation of the electronic transformer sometimes becomes unstable. For example, an output of the electronic transformer becomes intermittent and flickering and noise occur.

On the other hand, in the luminaire 10 and the lighting circuit 12 according to this embodiment, the lighting circuit 12 includes the first switching circuit 31 and the second switching circuit 32. According to the operation of the first switching circuit 31, an electric current necessary for the operation of the electronic transformer flows to the control device 4. According to the operation of the second switching circuit 32, an electric current and a voltage corresponding to the light-emitting element 16 are supplied to the light-emitting unit 14. Therefore, in the luminaire 10 and the lighting circuit 12 according to this embodiment, even if the luminaire 10 is connected to the control device 4 including the electronic transformer, it is possible to normally light the light-emitting element 16.

In the luminaire 10 and the lighting circuit 12 according to this embodiment, the averaging circuit 40 is electrically connected between the rectifying circuit 22 and the first switching circuit 31. The averaging circuit 40 generates, on the basis of the pulsating voltage output from the rectifying circuit 22, an averaged signal corresponding to the conduction angle control. Consequently, for example, it is possible to cope with, with a simple configuration, the dimming of the light-emitting element 16.

In the luminaire 10 and the lighting circuit 12 according to this embodiment, the first control unit 41 substantially fixes the input current flowing to the input unit 20. Consequently, for example, it is possible to further stabilize the operation of the control device 4 (the electronic transformer). Note that the input current only has to be, for example, equal to or larger than an electric current necessary for the operation of the electronic transformer and does not always have to be fixed. The input current detecting circuit 43 is provided according to necessity and can be omitted.

In the luminaire 10 and the lighting circuit 12 according to this embodiment, the first control unit 41 substantially fixes the first voltage output from the first switching circuit 31. Consequently, for example, it is possible to further stabilize the operation of the second switching circuit 32. Note that the first voltage does not always have to be fixed. The output voltage detecting circuit 44 is provided according to necessity and can be omitted.

In the luminaire 10 and the lighting circuit 12 according to this embodiment, the first control unit 41 sets the first voltage to be equal to or larger than the lower limit value necessary for the light emission of the light-emitting element 16. Consequently, for example, it is possible to further stabilize the operation of the second switching circuit 32. For example, even if a low dimming degree is set by the dimmer 7, it is possible to appropriately light the light-emitting element 16. For example, it is possible to more appropriately perform the dimming of the light-emitting element 16.

In the luminaire 10 and the lighting circuit 12 according to this embodiment, the second control unit 42 substantially fixes the output current output from the second switching circuit 32. Consequently, for example, it is possible to stably light the light-emitting element 16. Note that the output current does not always have to be fixed. The output current detecting circuit 45 is provided according to necessity and can be omitted as appropriate.

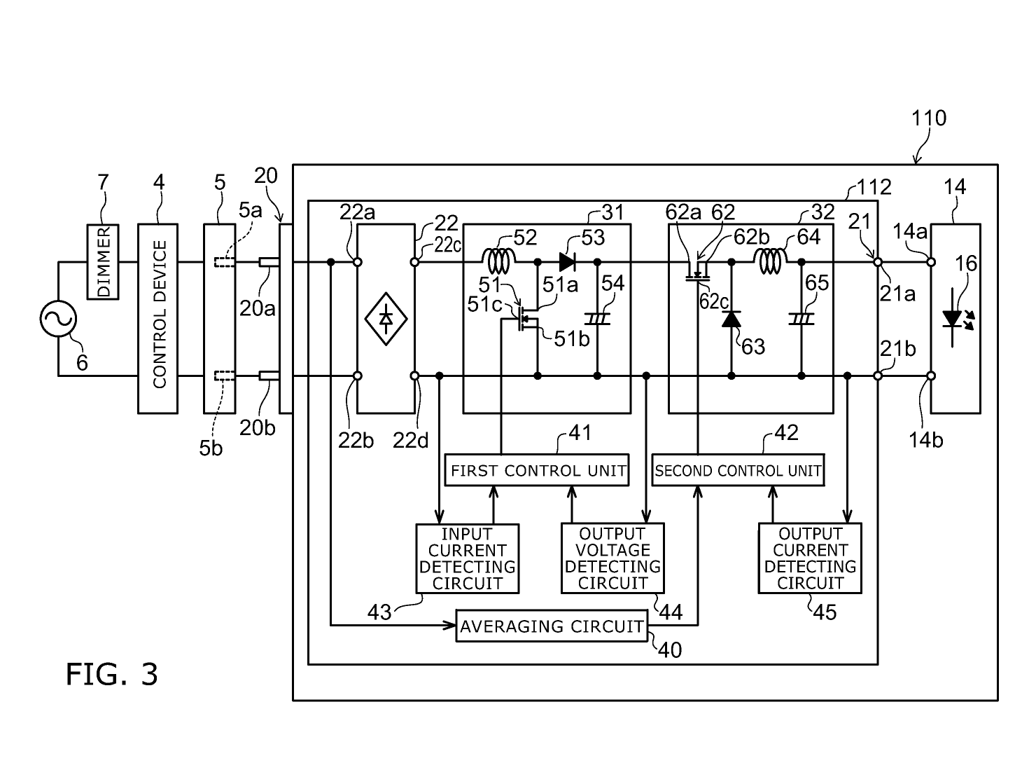

FIG. 3 is a block diagram schematically showing another luminaire according to the first embodiment.

As shown in FIG. 3, in a lighting circuit 112 of a luminaire 110, the averaging circuit 40 is electrically connected between the input unit 20 and the rectifying circuit 22. The averaging circuit 40 is electrically connected to, for example, the input terminal 22a. Consequently, an alternating-current voltage is input to the averaging circuit 40. The averaging circuit 40 generates, on the basis of the alternating-current voltage, a dimming signal corresponding to the conduction angle control of the dimmer 7. In this case, for example, the averaging circuit 40 may convert the alternating-current voltage into a pulsating voltage or a direct-current voltage. In this way, the averaging circuit 40 may be provided either in the pre-stage or in the post stage of the rectifying circuit 22.

### Second Embodiment

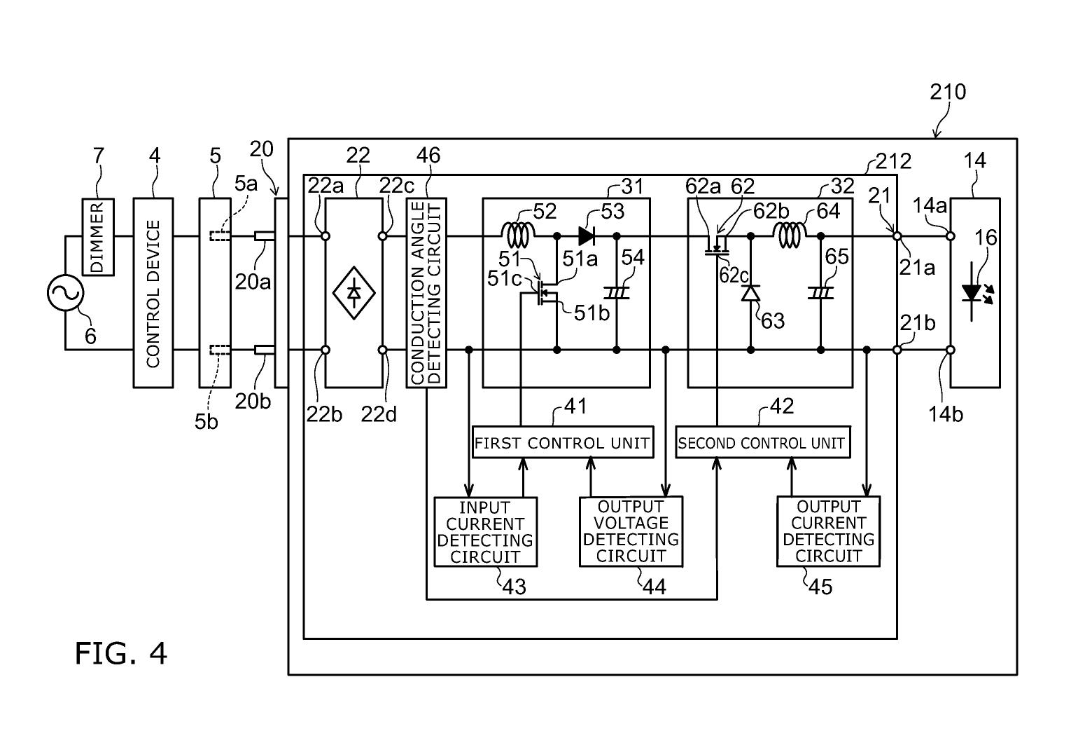

FIG. 4 is a block diagram schematically showing a luminaire according to a second embodiment.

As shown in FIG. 4, in a luminaire 210 in this example, a lighting circuit 212 includes a conduction angle detecting circuit 46 as a dimming signal generating circuit instead of the averaging circuit 40.

The conduction angle detecting circuit 46 is electrically connected between the rectifying circuit 22 and the first switching circuit 31. A pulsating voltage is input to the conduction angle detecting circuit 46. The conduction angle detecting circuit 46 generates, on the basis of the pulsating voltage, a dimming signal corresponding to the conduction angle control of the dimmer 7.

For example, the conduction angle detecting circuit 46 determines that the conduction angle control is in a shutoff state if a voltage value of the pulsating voltage is equal to or smaller than a predetermined value and determines that the conduction angle control is in a conduction state if the voltage value of the pulsating voltage is larger than the predetermined value. The conduction angle detecting circuit 46 generates, as the dimming signal, for example, a pulse signal (a PWM signal) in which a section determined as the shutoff state is set as Lo (e.g., ground potential) and a section determined as the conduction state is set as Hi (e.g., +5V).

In this way, the conduction angle detecting circuit 46 detects, for example, a voltage subjected to the conduction angle control by the dimmer 7. The conduction angle detecting circuit 46 generates, for example, according to positive property feed-forward control, a PWM signal, on-duty of which changes according to the detected voltage. Note that, contrary to the above, the section determined as the shutoff state may be set as Hi and the section determined as the conduction state may be set as Lo.

The conduction angle detecting circuit 46 is electrically connected to the second control unit 42. The conduction angle detecting circuit 46 outputs the generated PWM signal to the second control unit 42 as a dimming signal. The second control unit 42 determines, for example, on the basis of the PWM signal, a duty ratio of a pulse signal input to the second control electrode 62c. Consequently, a voltage value of the second voltage is controlled to a value corresponding to the conduction angle control of the dimmer 7.

As explained above, the dimming signal generating circuit may be the conduction angle detecting circuit 46 that generates, as the dimming signal, the PWM signal having the on-duty corresponding to the conduction angle control. In this example, the conduction angle detecting circuit 46 is connected to the post stage of the rectifying circuit 22. However, as in the lighting circuit 112 of a luminaire 110, the conduction angle detecting circuit 46 may be provided in the pre-stage of the rectifying circuit 22. The dimming signal generating circuit may be an arbitrary circuit that can generates, as the dimming signal, a signal corresponding to the conduction angle control.

In the embodiments, the examples in which the LED is used as the light-emitting element 16 are explained. The light-emitting element 16 is not limited to the LED. An arbitrary light-emitting element that is lit by being applied with a voltage equal to or larger than a predetermined value can be used. For example, an arbitrary light-emitting element having a forward voltage can be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting circuit comprising:
an input unit electrically connected to a control device that converts a first alternating-current voltage subjected to conduction angle control into a second alternating-current voltage having a different effective value and outputs the second alternating-current voltage;
an output unit electrically connected to a light-emitting unit, the light-emitting unit including a first terminal, a second terminal, and a light-emitting element electrically connected between the first terminal and the second terminal and configured to emit light when an electric current flows from the first terminal to the second terminal;
a rectifying circuit electrically connected between the input unit and the output unit and configured to rectify the second alternating-current voltage input via the input unit and convert the second alternating-current voltage into a rectified voltage;
a first switching circuit electrically connected between the rectifying circuit and the output unit, including a first switching element, and configured to convert the rectified voltage into a first voltage according to switching of the first switching element, the first switching element including a first electrode, a second electrode, and a first control electrode for switching a first state in which an electric current flows between the first electrode and the second electrode and a second state in which an electric current flowing between the first electrode and the second electrode is smaller than the electric current in the first state, and the first electrode and the second electrode being connected to the light-emitting element in parallel;
a second switching circuit electrically connected between the first switching circuit and the output unit, including a second switching element, and configured to convert the first voltage into a second voltage of a direct current according to switching of the second switching element and output the second voltage of the direct current to the output unit, the second switching element including a third electrode, a fourth electrode, and a second control electrode for switching a third state in which an electric current flows between the third electrode and the fourth electrode and a fourth state in which an electric current flowing between the third electrode and the fourth electrode is smaller than the electric current in the third state, and the third electrode and the fourth electrode being connected to the light-emitting element in series;
a dimming signal generating circuit electrically connected between the input unit and the rectifying circuit or between the rectifying circuit and the first switching circuit and configured to generate a dimming signal corresponding to the conduction angle control on the basis of one of the second alternating-current voltage and the rectified voltage;
a first control unit electrically connected to the first control electrode and configured to control the switching of the first switching element and set an effective value of an electric current flowing to the input unit to be equal to or larger than a predetermined value; and
a second control unit electrically connected to the second control electrode and the dimming signal generating circuit and configured to control the switching of the second switching element and set the second voltage to a voltage value corresponding to the dimming signal.

2. The circuit according to claim 1, wherein the dimming signal generating circuit is an averaging circuit configured to generate, as the dimming signal, an averaged signal obtained by averaging one of the second alternating voltage and the rectified voltage.

3. The circuit according to claim 2, wherein the averaging circuit is electrically connected between the rectifying circuit and the first switching circuit and generates the averaged signal on the basis of the rectified voltage.

4. The circuit according to claim 2, wherein the averaging circuit is electrically connected between the input unit and the rectifying circuit and generates the averaged signal on the basis of the second alternating-current voltage.

5. The circuit according to claim 1, wherein the dimming signal generating circuit is a conduction angle detecting circuit configured to detect a conduction angle of one of the second alternating-current voltage and the rectified voltage and generate, as the dimming signal, a pulse signal corresponding to the conduction angle.

6. The circuit according to claim 5, wherein the conduction angle detecting circuit determines that the conduction angle control is in a shutoff state if a voltage value of one of the second alternating-current voltage and the rectified voltage is equal to or smaller than a predetermined value and determines that the conduction angle control is in a conduction state if the voltage value is larger than the predetermined value.

7. The circuit according to claim 1, wherein the first switching circuit converts the rectified voltage into the first voltage of a direct current.

8. The circuit according to claim 1, wherein the first switching circuit is a rising voltage chopper circuit.

9. The circuit according to claim 1, wherein the second switching circuit is a falling voltage chopper circuit.

10. The circuit according to claim 1, wherein the first control unit fixes an effective value of an electric current flowing to the input unit.

11. The circuit according to claim 10, further comprising an input current detecting circuit configured to detect a current value of an input current flowing to the input unit and input a detection result to the first control unit, wherein
the first control unit fixes, on the basis of the detection result of the input current detecting circuit, the effective value of the electric current flowing to the input unit.

12. The circuit according to claim 1, wherein the first control unit fixes an effective value of the first voltage.

13. The circuit according to claim 12, further comprising an output voltage detecting circuit configured to detect a voltage value of the first voltage and input a detection result to the first control unit, wherein
the first control unit fixes the effective value of the first voltage on the basis of the detection result of the output voltage detecting circuit.

14. The circuit according to claim 1, further comprising an output current detecting circuit configured to detect an output current output from the second switching circuit and input a detection result to the second control unit, wherein
the second control unit controls the switching of the second switching element on the basis of the detection result of the output current detecting circuit.

15. The circuit according to claim 14, wherein the second control unit fixes an absolute value of the output current on the basis of the detection result of the output current detecting circuit.

16. The circuit according to claim 1, wherein
the light-emitting unit causes the light-emitting element to emit light if a voltage between the first terminal and the second terminal is set to be equal to or larger than a lower limit value, and
the first control unit sets an effective value of the first voltage to be equal to or larger than the lower limit value.

17. The circuit according to claim 1, wherein the input unit is electrically connected to the control unit via a socket.

18. The circuit according to claim 1, wherein the control device includes an electronic transformer and converts, with the electronic transformer, the first alternating-current voltage into the second alternating-current voltage.

19. The circuit according to claim 1, wherein the light-emitting element is a light-emitting diode.

20. A luminaire comprising:
a light-emitting unit including a first terminal, a second terminal, and a light-emitting element electrically connected between the first terminal and the second terminal and configured to emit light when an electric current flows from the first terminal to the second terminal; and
a lighting circuit including:
an input unit electrically connected to a control device that converts a first alternating-current voltage subjected to conduction angle control into a second alternating-current voltage having a different effective value and outputs the second alternating-current voltage;
an output unit electrically connected to a light-emitting unit;
a rectifying circuit electrically connected between the input unit and the output unit and configured to rectify the second alternating-current voltage input via the input unit and convert the second alternating-current voltage into a rectified voltage;
a first switching circuit electrically connected between the rectifying circuit and the output unit, including a first switching element, and configured to convert the rectified voltage into a first voltage according to switching of the first switching element, the first switching element including a first electrode, a second electrode, and a first control electrode for switching a first state in which an electric current flows between the first electrode and the second electrode and a second state in which an electric current flowing between the first electrode and the second electrode is smaller than the electric current in the first state, and the first electrode and the second electrode being connected to the light-emitting element in parallel;
a second switching circuit electrically connected between the first switching circuit and the output unit, including a second switching element, and configured to convert the first voltage into a second voltage of a direct current according to switching of the second switching element and output the second voltage of the direct current to the output unit, the second switching element including a third electrode, a fourth electrode, and a second control electrode for switching a third state in which an electric current flows between the third electrode and the fourth electrode and a fourth state in which an electric current flowing between the third electrode and the fourth electrode is smaller than the electric current in the third state, and the third electrode and the fourth electrode being connected to the light-emitting element in series;
a dimming signal generating circuit electrically connected between the input unit and the rectifying circuit or between the rectifying circuit and the first switching circuit and configured to generate a dimming signal corresponding to the conduction angle control on the basis of one of the second alternating-current voltage and the rectified voltage;
a first control unit electrically connected to the first control electrode and configured to control the switching of the first switching element and set an effective value of an electric current flowing to the input unit to be equal to or larger than a predetermined value; and
a second control unit electrically connected to the second control electrode and the dimming signal generating circuit and configured to control the switching of the second switching element and set the second voltage to a voltage value corresponding to the dimming signal.
